(19) United States
(12) Patent Application Publication
(10) Pub. No.: US 2023/0225547 A1
(43) Pub. Date: Jul. 20, 2023

(54) COFFEE MACHINE WITH AUTOMATIC LOCKING OF THE FILTER-HOLDER

(71) Applicant: CARIMALI S.P.A., Bergamo (IT)

(72) Inventors: Andrea DOGLINI MAJER, Chignolo d'Isola (IT); Lorenzo IEMMA, Chignolo d'Isola (IT); Allessandro CERIANI, Chignolo d'Isola (IT)

(73) Assignee: CARIMALI S.P.A., Bergamo (IT)

(21) Appl. No.: 18/009,447

(22) PCT Filed: Jun. 18, 2021
(86) PCT No.: PCT/IB2021/055402

§ 371 Date: Dec. 9, 2022

(30) Foreign Application Priority Data
Jun. 19, 2020 (EP) 20181248.4
Oct. 13, 2020 (IT) 102020000024139

(51) Int. Cl. A47J 31/44

(52) U.S. Cl. CPC A47J 31/446

(57) ABSTRACT

A coffee machine has a supporting body that delivers hot water for producing a beverage. A filter-holder is can be filled with a brewing material and releasably coupleable to the supporting body to receive hot water therefrom for brewing the brewing material to produce the beverage. A coupling device includes a first coupling part mounted on the supporting body and a second coupling part carried by the filter-holder. The coupling device is configured to tighten the filter-holder by a relative rotation of the first coupling part and the second coupling part. An automation device is configured to cause relative rotation of the first coupling part and the second coupling part. A user interface is configured to cause the coupling device to tight-couple and uncouple and/or a beverage delivery to start and stop in response to sensed actions or forces.

### CROSS-REFERENCE TO RELATED APPLICATIONS

This application is a national stage application, filed under 35 U.S.C. § 371, of International Patent Application No. PCT/162021/055402, filed on Jun. 18, 2021, which claims priority to European patent application no. 20181248.4 filed on Jun. 19, 2020 and Italian patent application no. 102020000024139 filed on Oct. 13, 2020, the entire to disclosures of all of which are incorporated herein by reference.

### BACKGROUND OF THE DISCLOSURE

### 1. Field of the Disclosure

The present disclosure relates to the field of machines for preparing coffee or similar beverages, and in particular it relates to a semi-automatic coffee machine for professional use in bars or for domestic use.

### 2. Description of Related Art

As is well known, semi-automatic coffee machines comprise those machines in which a coffee beverage is largely made manually by an operator, while other operations are controlled automatically by an electronic control unit.

A typical operation that has to be carried out manually is, for example, loading the ground coffee, which normally requires the operator to remove the so-called filter-holder from the machine to load a dose of loose ground coffee or a pod or a disposable capsule into the filter-holder, and then to fluidtight couple the filter-holder to an annular supporting body which forms an outlet of a hot water injection assembly of the coffee machine.

Another operation that is controlled directly by the operator, normally by means of a button, is the start and, vice versa, the stop of the beverage delivery. In some types of semi-automatic machines, the beverage delivery is stopped automatically, based on a setting of the “length” of the coffee to be delivered in the cup.

In general, the filter-holder is coupled to the annular supporting body by means of a bayonet coupling device formed of at least two radial fins carried by the filter-holder and a corresponding number of slots formed in the annular supporting body.

Each fin, or, alternatively, each slot, is partially delimited by an inclined plane, which, when the filter-holder is coupled to the annular supporting body and the fins are displaced along the respective slots, engages an abutment plane formed on the corresponding slot, or, respectively, on the corresponding fin, so as to cause an axial displacement of the filter-holder towards the annular supporting body and consequent fluid-tight coupling of a free edge of the filter-holder against a frontal seal carried by the annular supporting body.

From the operator's point of view, coupling the filter-holder to the supporting annular body of the water injection assembly involves two sequential operations in order to bring the filter-holder first into an insertion configuration, in which the filter-holder is inserted in the annular body, and then into a tight coupling configuration, in which the filter-holder is tight-coupled onto the annular supporting body.

The insertion configuration is usually reached by vertically moving the filter-holder from bottom upwards so that the filter-holder is coupled frontally to the annular supporting body and the fins are aligned with corresponding slots. Typically, in the insertion configuration, the filter-holder is angularly offset (leftwards) from a frontal configuration with respect to the operator.

The tight coupling configuration is instead reached by rotating the filter-holder, typically by about 30°-40° and anticlockwise, starting from the insertion configuration, so as to move the fins along the slots until the free edge of the filter-holder is compressed against the frontal seal of the annular supporting body. Resultingly, in the tight coupling configuration the filter-holder is angularly offset from the insertion configuration and is typically placed frontally to the operator.

EP 3 037 023 A1 discloses a connecting device for connecting a filter-holder of an espresso machine to a hot water dispensing group for producing a beverage. The filter-holder comprises a body, provided with a handle, with an inner cavity delimited by a cylindrical wall and defining a housing for a filter, to be loaded with ground coffee. The cavity is open at an end facing the dispensing group, is closed with a bottom wall at the opposite end, and is provided with a beverage dispensing opening formed in the bottom wall. The filter-holder further comprises a pair of diametrically opposed fins projecting radially from the side wall and extending circumferentially outside the cavity. The water dispensing group comprises an opening designed to accommodate the open end of the inner cavity of body of the filter-holder and a pair of helical guides extending around an axis orthogonal to the plane on which the filter-holder connects to the water dispensing group. The helical guides are arranged around the opening and are each designed to accommodate thereon, by means of a bayonet coupling, a corresponding fin of the pair of fins of the filter-holder. The connecting device comprises a plate-like element fixed to the water delivery group and provided with an opening aligned with the opening of the water dispensing group and with a tubular cavity, which is open at both axial ends and is aligned with the axial openings and in a distal position relative to the opening of the water dispensing group. The connecting device further comprises an annular element which is arranged inside the tubular cavity of the plate-like element so as to freely rotate around the longitudinal axis thereof. The pair of helical guides is formed on the internal wall of the annular element and motor means are provided to angularly displace the annular element so as to servo-assist the insertion of the filter-holder into the water delivery group.

### SUMMARY OF THE DISCLOSURE

The Applicant has found that known coffee machines of the type described above have a number of drawbacks that are well known to the operators in the sector.

In particular, the Applicant has found that one of these drawbacks is represented by the fact that the mechanical seal between the filter-holder and the water outlet of the water injection group is totally dependent on the effectiveness of the tight coupling of the coupling device, which is left exclusively to the action of the operator, i.e., the extent to which the operator is able to compress the filter-holder against the annular supporting body when rotating it from the insertion configuration to the tight coupling configuration.

As is well known, this operation requires not only a certain technique on the part of the operator, but above all a considerable effort, which can be extremely onerous from a physical point of view when it has to be repeated hundreds or even thousands of times a day, as in the case of a bartender, for example.

Moreover, the effort of tight coupling the filter-holder is not even the only one required to the operator, as the removal thereof also requires the operator to apply a not negligible force, at least in the first phase of the rotation in order to move the filter-holder away from the tight coupling configuration.

The Applicant has also found that another of the drawbacks of known coffee machines of the type described above is represented by the fact that the activation of the various operating functions of the coffee machines requires various interactions of the operator with different elements of the coffee machines.

The aim of the present disclosure is to provide improvements to remedy the above-described drawbacks.

According to the present disclosure, a coffee machine is provided, as claimed in the appended claims.

### BRIEF DESCRIPTION OF THE DRAWINGS

FIG. 1 shows, in perspective view and with parts removed for the sake of clarity, an embodiment of the coffee machine of the present disclosure.

FIG. 2 shows, in exploded view, a detail of a water injection group of the coffee machine shown in FIG. 1, and the filter-holder of the coffee machine in a disengagement configuration, in which filter-holder is disengaged from the water injection group.

FIG. 3 shows the detail shown in FIG. 2 in an assembled configuration, and the filter-holder in the aforementioned disengagement configuration.

FIG. 4 shows, with parts removed for the sake of clarity, the coffee machine shown in FIG. 1 during insertion of the filter-holder in the water injection group.

FIGS. 5 and 6 show the filter-holder engaged with the water injection group in an initial uncoupled configuration and in a final tight-coupled configuration of the filter-holder and the water injection group, respectively.

FIG. 7 shows, in cross-section, the filter-holder and part of the water injection group arranged in the above-mentioned final tight-coupled configuration.

FIG. 8 shows, in exploded view, a detail of the water injection group in a different embodiment of the coffee machine of the present disclosure and the filter-holder of the coffee machine in a disengagement configuration.

FIG. 9 shows the detail shown in FIG. 8 in an assembled configuration and the filter-holder in the above-mentioned disengagement configuration.

FIG. 10 shows, with parts removed for the sake of clarity, the coffee machine shown in FIG. 8 during insertion of the filter-holder on the water injection group.

FIGS. 11 and 12 show, in perspective view and, respectively, in a bottom view, the filter-holder shown in FIG. 10 engaged with the water injection group in an initial uncoupled configuration.

FIGS. 13 and 14 show, in perspective view and, respectively, in bottom view, the filter-holder shown in FIG. 10 engaged with the water injection group in a final tight-coupled configuration.

FIG. 15 shows, in cross-section, the filter-holder and part of the water injection group arranged in the final tight-coupled configuration shown in FIG. 14.

FIG. 16 shows, in exploded view, a detail of the water injection group in a further different embodiment of the coffee machine of the present disclosure, and the filter-holder of the coffee machine in a disengagement configuration.

FIG. 17 shows the detail shown in FIG. 8 in an assembled configuration and the filter-holder in the above-mentioned disengagement configuration.

FIG. 18 shows, with parts removed for the sake of clarity, the coffee machine shown in FIG. 16 during insertion of the filter-holder on the water injection group;

FIGS. 19 and 20 show, in perspective view and, respectively, in bottom view, the filter-holder shown in FIG. 18 engaged with the water injection group in an initial uncoupled configuration.

FIGS. 21 and 22 show, in perspective view and, respectively, in bottom view, the filter-holder shown in FIG. 18 engaged with the water injection group in a final tight-coupled configuration.

FIG. 23 shows, in cross-section, the filter-holder and part of the water injection group arranged in the final tight-coupled configuration shown in FIGS. 21 and 22.

FIG. 24 shows, in perspective and with parts removed for the sake of clarity, a variant of the water injection group of the coffee machine of the present disclosure.

FIGS. 25, 26 and 27 show, in front view, three variants of a detail of the coffee machine of the present disclosure.

### DETAILED DESCRIPTION OF THE DISCLOSURE

The present disclosure will now be described in detail with reference to the accompanying drawings to enable a skilled person to realize and use it. Various modifications to the embodiments presented shall be immediately clear to persons skilled in the art and the general principles disclosed herein could be applied to other embodiments and applications but without thereby departing from the scope of protection of the present disclosure as defined in the appended claims. Therefore, the present disclosure should not be considered limited to the embodiments described and shown, but should be granted the widest protective scope in accordance with the features described and claimed.

Where not otherwise defined, all the technical and scientific terms used herein have the same meaning commonly used by persons of ordinary skill in the field pertaining to the present disclosure. In the event of a conflict, this description, including the definitions provided, shall be binding. Furthermore, the examples are provided for illustrative purposes only and as such should not be considered limiting.

In order to facilitate understanding of the embodiments described herein, reference will be made to some specific embodiments and a specific language will be used to describe them. The terminology used herein is for the purpose of describing only particular embodiments, and is not intended to limit the scope of the present disclosure.

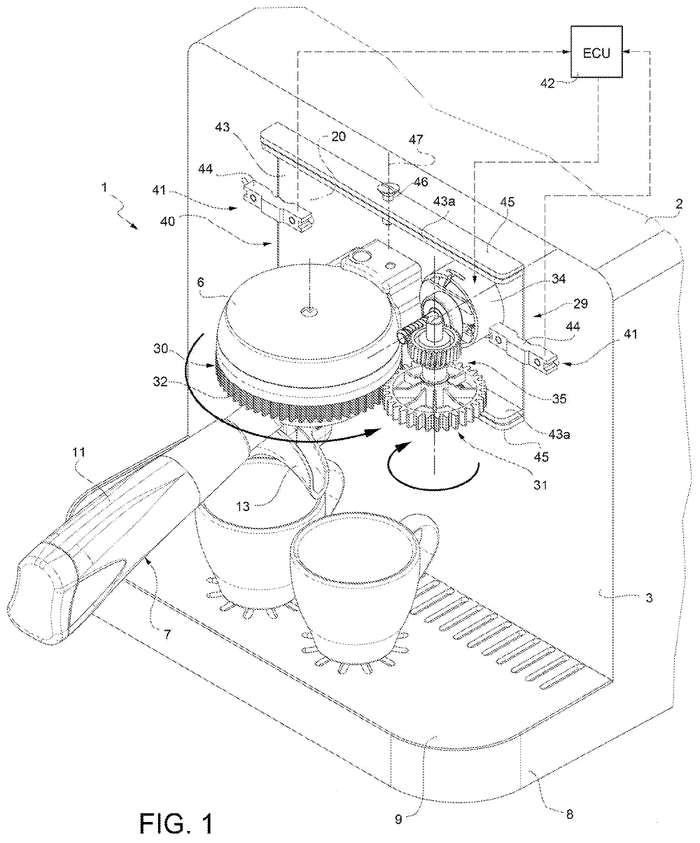

FIG. 1 shows and denotes as a whole with the reference numeral 1 a semi-automatic coffee machine commonly for professional use in bars or for domestic use.

The coffee machine 1 comprises a box-shaped frame 2, which is delimited frontally, with respect to an operator, by a front wall 3, and a plurality of components for the production of coffee which are supported by the frame 2 and comprising a boiler 4 for the production of hot water arranged inside the frame 2.

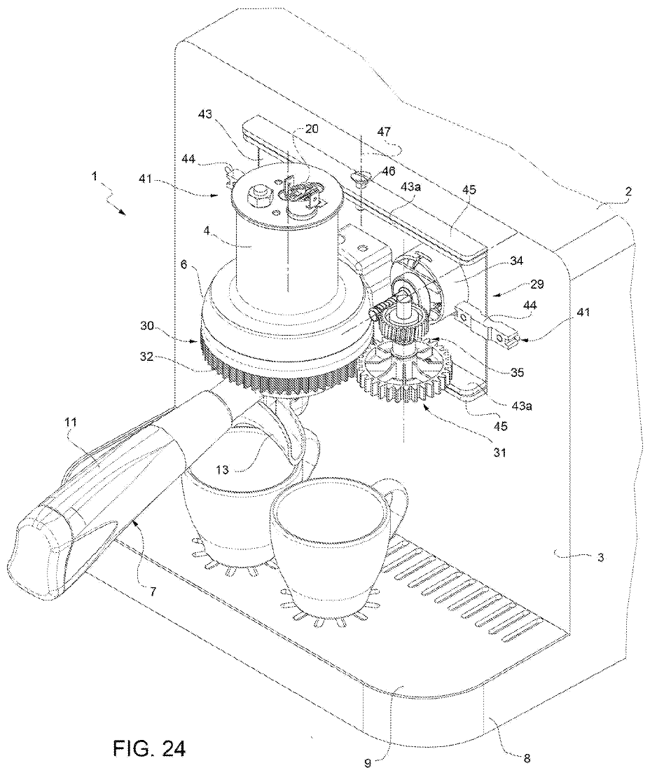

In a different embodiment, shown in FIG. 24, the boiler 4 for the production of hot water is arranged outside the frame 2.

The front wall 3 can be either an external wall of the coffee machine 1 or an internal wall of the coffee machine 1 in turn protected by an external casing (not shown) which completely or partially covers the frame 2.

The boiler 4 comprises a hot water supply conduit 5, an end portion of which extends within a supporting body 6 mounted to protrude from the front wall 3 and configured to be releasably engaged by a filter-holder 7, which is designed to be filled with either loose ground coffee or a disposable coffee pod or capsule and to receive water from the supporting body 6.

From the lower end of the front wall 3, a drip tray 8 protrudes which is closed above by a grid 9 to support, in use, one or more cups underneath the filter holder 7.

The filter-holder 7 comprises a cup 10 open at the top and a handle 11 extending radially from the cup 10 and designed to be gripped by an operator to couple and uncouple the cup 10 to/from the supporting body 6.

The cup 10 is provided at the bottom with a conduit 12 for the delivery of the coffee beverage, to which a two-way delivery spout 13 can be connected, preferably removably, to allow the coffee beverage to be delivered in two cups at the same time.

The cup 10 houses internally a cup-shaped filter 14 which is designed to receive either loose ground coffee or a coffee pod or capsule. Preferably, the filter 14 is made of metallic material, conveniently stainless steel, and has a perforated bottom wall and a lateral wall ending with an edge 15 which is U-folded outwards and is arranged astride a free end edge of the cup 10.

The cup 10 has, close to its open end, a number of projections or fins 16, which radially project outwardly from the cup 10 and define a portion of a coupling device 17, of the type commonly referred to as a “bayonet”, designed to removably couple the cup 10, and hence the filter-holder 7, to the supporting body 6. In the examples shown in the accompanying FIGS., the fins 16 are in number of three and are mutually equispaced around a longitudinal axis of the cup 10. In variants not shown, the fins 16 could be in number of two or more than three.

The fins 16 lie substantially on a horizontal plane perpendicular to the longitudinal axis of the cup 10 and are delimited at the bottom by respective inclined planes 18, all of which have the same inclination and orientation relative to the lying plane of the fins 16.

As shown in the accompanying FIGS., the supporting body 6 is generically cup-shaped, with a concavity facing downwards, and comprises a tubular lateral wall 19, coaxial to a substantially vertical axis 20, and a bottom wall, through which the aforementioned end portion of the hot water supply conduit 5 is formed.

A hot water distribution shower 21 is mounted at the centre of the bottom wall, fluidically communicates with the hot water supply conduit 5, and is surrounded by an annular cavity 22 coaxial to the axis 20 and housing a frontal seal 23 which, as will be described in more detail below, has the function of fluid-tight coupling the filter-holder 7 and the supporting body 6 when the coupling device 17 is tight-coupled.

Furthermore, a number of transverse projections 24 are associated with the supporting body 6, which are arranged on the supporting body 6 so as to cooperate with the fins 16 when the filter-holder 7 is coupled to the supporting body 6. The transverse projections 24 define, together with the fins 16, the aforementioned coupling device 17, of which they form a further portion.

For this purpose, the transverse projections 24 are delimited at the top, i.e., towards the bottom wall of the supporting body 6, by respective abutment planes 25, which are coplanar to each other and perpendicular to the axis 20 and are configured to slidably engage with the inclined planes 18 in response to a relative rotation of the transverse projections 24 and the fins 16, in the manner and forms described below, so as to cause an upward displacement of the filter-holder 7 and the compression of the latter against the supporting body 6, resulting in a tight coupling of the coupling device 17.

In particular, as will be further clarified in the following description, the coupling of the filter-holder 7 to the supporting body 6 comprises a first completely manual step during which the operator brings the cup 10 of the filter-holder 7 close to the supporting body 6 through a vertical upward movement in order to arrange the filter-holder 7 in an insertion configuration, in which the fins 16 are arranged in the free spaces between the transverse projections 24, and the edge 15 of the filter 14 engages the cavity 22 and faces the, and preferably contacts the, frontal seal 23.

Conveniently, in order to ease the correct positioning of the filter-holder 7 in the insertion configuration and to keep it stable in this configuration prior to tight coupling the coupling device 17, a magnetic positioning device 26 is there is provided, which comprises a number of permanent magnets 27, each fixed to a respective fin 16, and a number of permanent magnets 28 mounted along the periphery of the bottom wall of the cup 10 in positions such that, when the filter-holder 7 is approached to the supporting body 6, the permanent magnets 28 are facing corresponding permanent magnets 27 of the fins 16. Preferably, the attractive force between the pairs of facing permanent magnets 27 and 28 is enough to hold the filter-holder 7 in the insertion configuration, even if the operator completely abandons the filter-holder 7 before the coupling device 17 is tight-coupled.

The coupling of the filter-holder 7 to the supporting body 6 further comprises a second step during which the coupling device 17 is tight-coupled. In this step, the fins 16 and the projections 24 are relatively rotated and the engagement between the inclined planes 18 and the abutment planes 25 causes the filter-holder 7 to move from the insertion configuration to a tight coupling configuration, in which the filter-holder 7 is arranged at a higher level than in the insertion configuration and the edge 15 of the filter 14 is compressed against the frontal seal 23 so as to achieve a fluid-tight coupling with the latter.

The coffee machine 1 further comprises an automation device 29 configured to automatically tight-couple and uncouple the coupling device 17 so as to relieve the operator of the physical effort associated with such operations.

In this respect, it should be noted that, since the relative rotation of the fines 16 and the transverse projections 24 causes the coupling device 17 to be tight-coupled and uncoupled, there is no conceptual difference, but only an implementation difference, between a type of actuation of the coupling device 17, in the following for descriptive convenience indicated as the first type of actuation, in which the transverse projections 24 rotate relative to the fins 16, and a type of actuation of the coupling device 17, in the following for descriptive convenience indicated as the second type of actuation, in which the fines 16 rotate relative to the transverse projections 24.

The automation device 29 comprises a toothed ring nut 30 carried by the supporting body 6 and mounted to rotate around the axis 20, and a drive device 31 operatively coupled to the toothed ring nut 30 to rotate it around the axis 20 and move it between a rest configuration, in which an operator is allowed to couple the filter-holder 7 to the supporting body 6 in order to arrange it in the insertion configuration, and an operating configuration, in which the filter-holder 7 is in the tight coupling configuration.

Depending on the type of actuation of the coupling device 17, the toothed ring nut 30 rotates the transverse projections 24 relative to the fins 16, or, vice versa, the fins 16 relative to the transverse projections 24 to tight-couple and uncouple the coupling device 17.

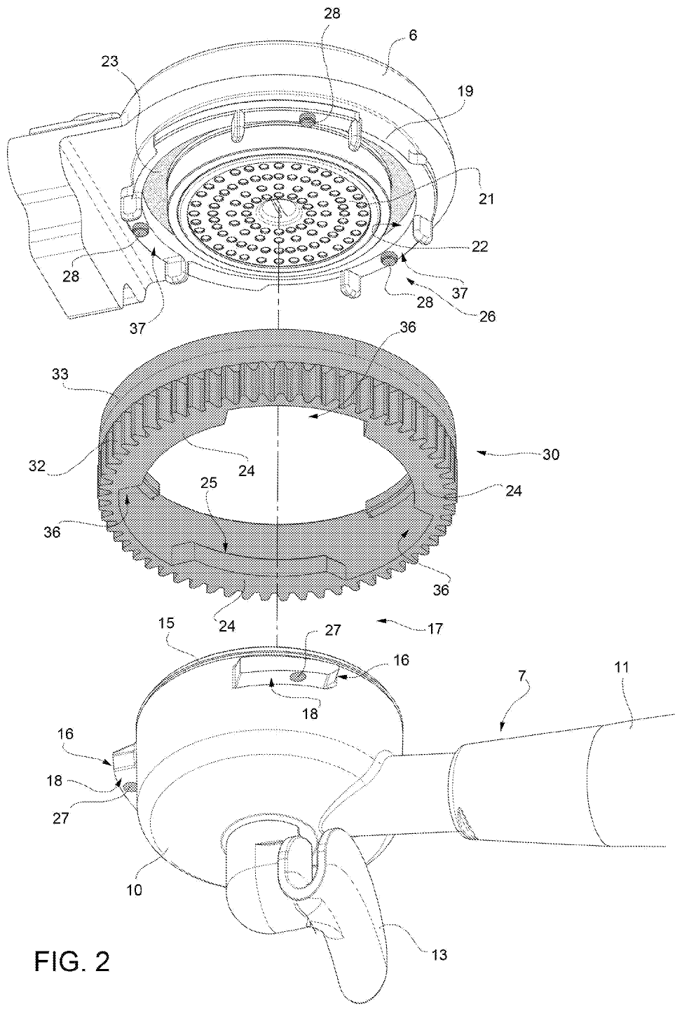

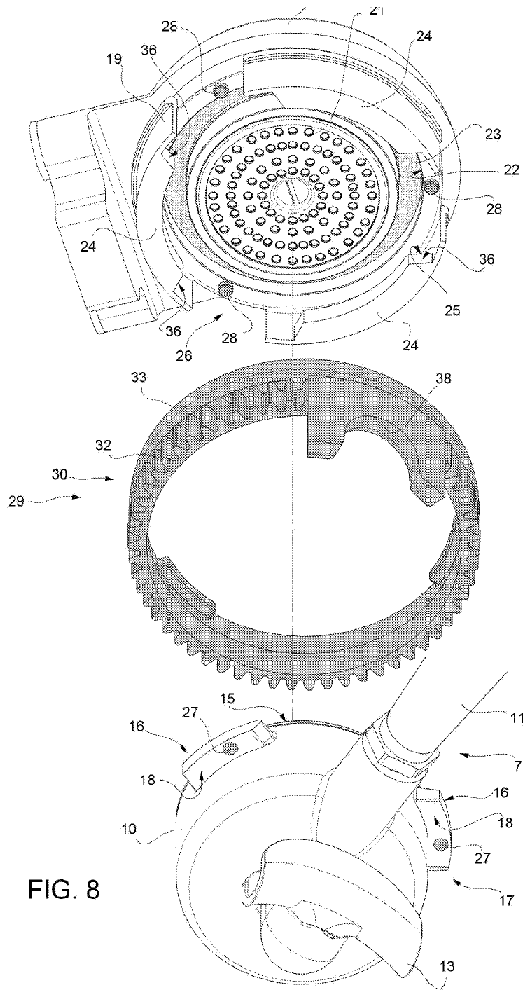

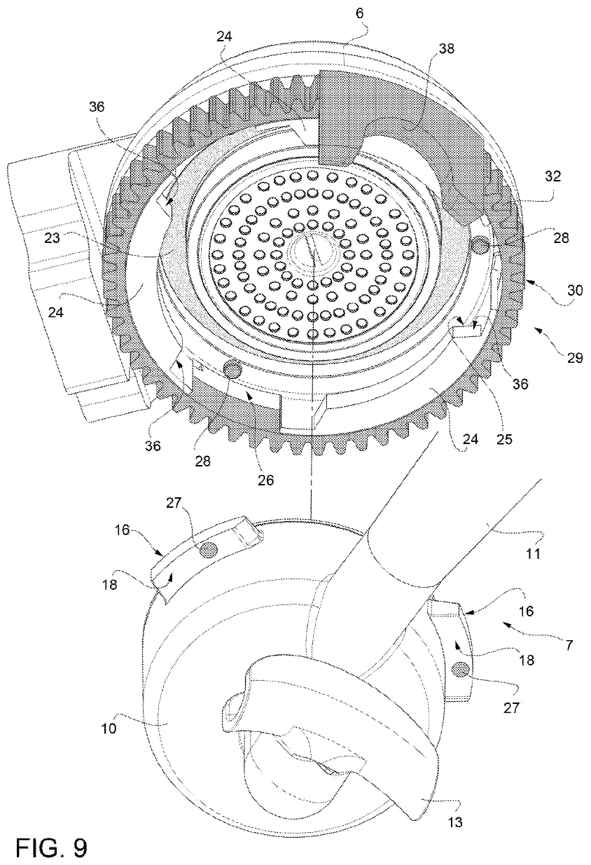

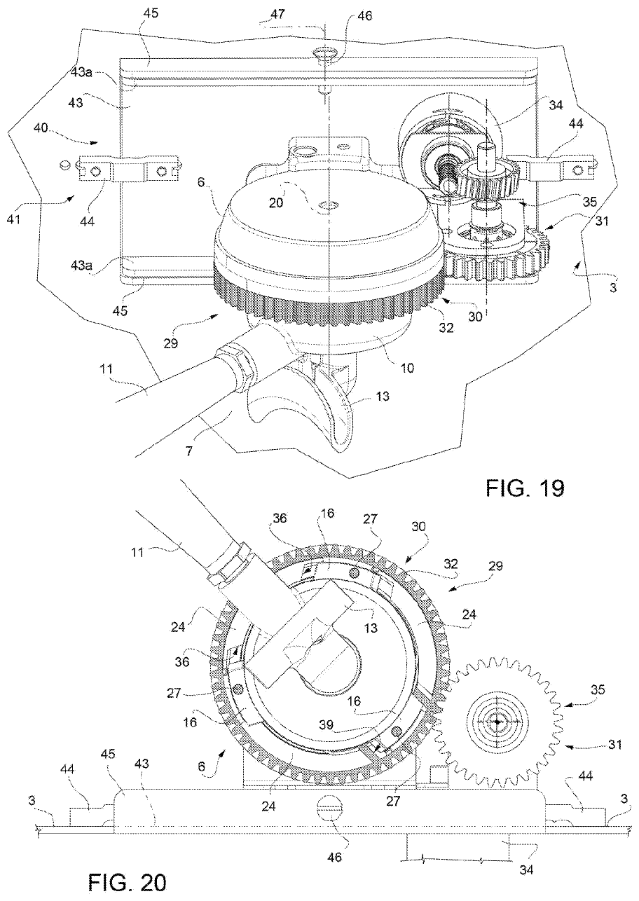

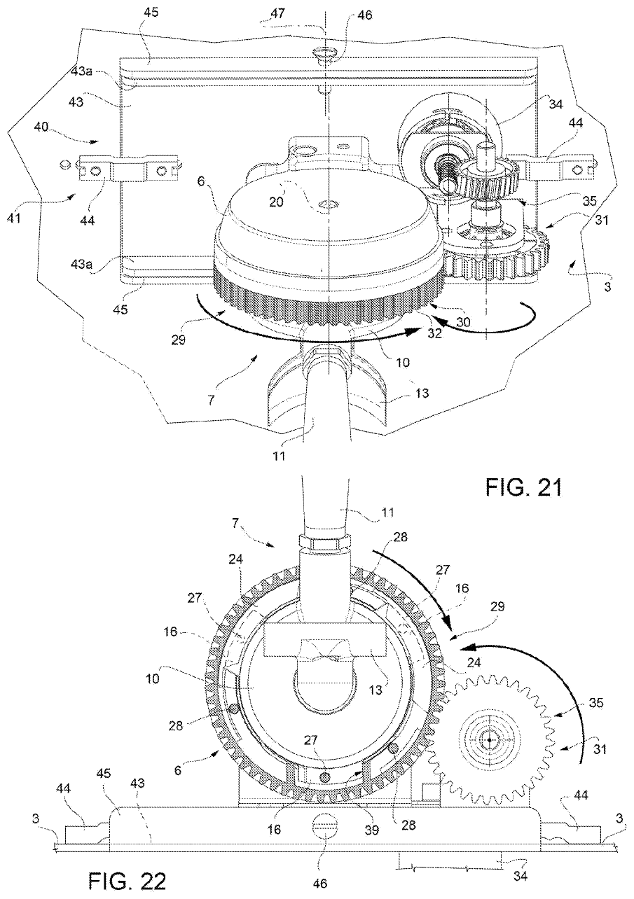

In particular, in the first type of actuation shown in FIGS. 2-7, the toothed ring nut 30 is mounted integral with the transverse projections 24 to rotate them relative to the fins 16, while in the second type of actuation (FIGS. 8-15 and 16-23), the toothed ring nut 30 is angularly coupled to the fins 16 to rotate them relative to the transverse projections 24.

The toothed ring nut 30 comprises an external toothing 32 coaxial to the axis 20 and formed on an annular body 33 rotatably mounted on the tubular side wall 19.

Preferably, the drive device 31 comprises an electric motor 34, arranged in the frame 2, and a gear transmission 35 designed to receive rotational motion from an output shaft of the electric motor 34 and transmit it, suitably reduced, to the ring nut 30. Preferably, the output shaft of the electric motor 34 extends through the front wall 3 and the gear transmission 35 is arranged outside the frame 2.

In an embodiment not shown, the drive device 31 comprises a gear motor entirely housed in the frame 2.

In the following, the automation device 29 will be described in more detail with explicit reference to each one of the two aforementioned types of actuation of the coupling device 17.

First Type of Actuation of the Coupling Device

FIGS. 2 to 7 show an embodiment of the coffee machine 1 operating according to the first type of actuation of the coupling device 17, i.e., the type in which the transverse projections 24 rotate relative to the fins 16 and are rotated about the axis 20 by the toothed ring nut 30.

In this embodiment, the toothed ring nut 30, which is rotatably mounted on the tubular side wall 19, substantially forms an extension of the tubular lateral wall 19 and brings integrally the transverse projections 24 close to its own free end edge.

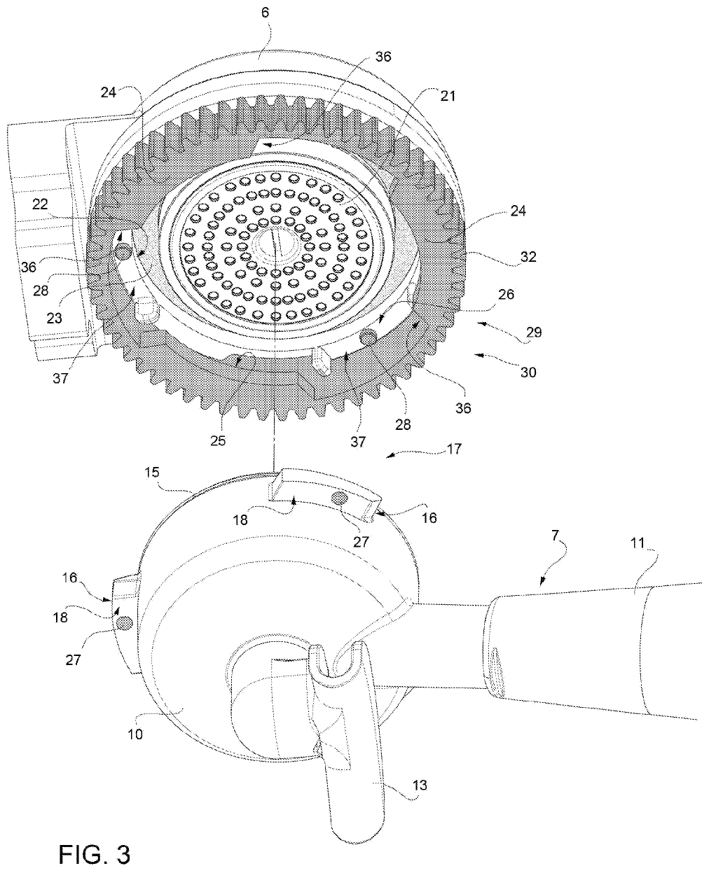

As shown in FIGS. 2 and 3, the transverse projections 24 extend from an inner surface of the toothed ring nut 30 towards the axis 20, are arranged with the respective abutment planes 25 facing the bottom wall of the supporting body 6, and are evenly distributed around the axis 20 such that free spaces 36 of sufficient angular width are circumferentially defined therebetween in order to allow the fines 16 to pass through the free spaces 36 in a direction parallel to the axis 20.

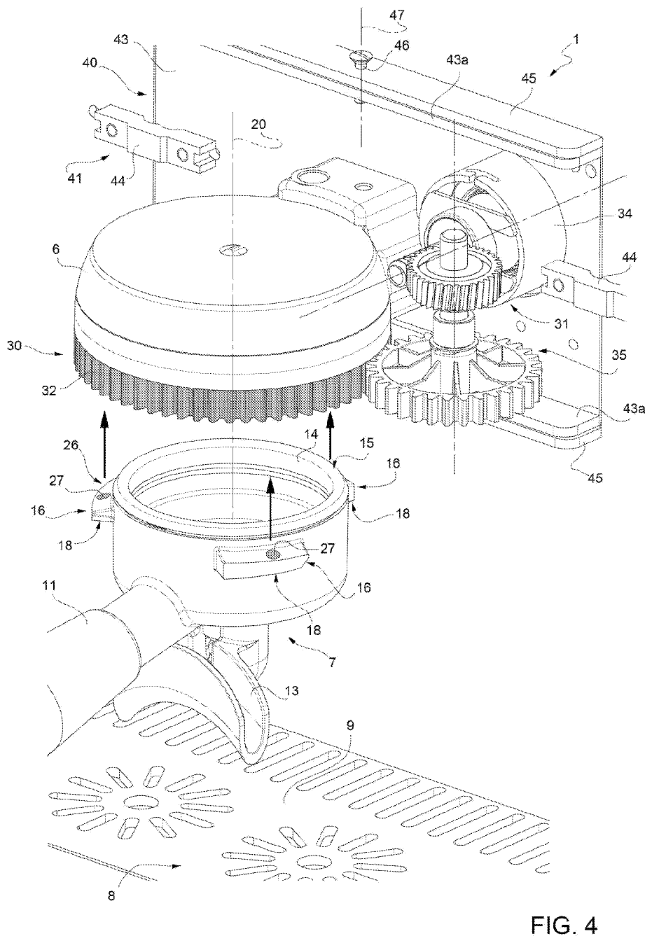

The supporting body 6 has a plurality of seats 37, which are distributed around the seal 23 so as to be axially aligned with corresponding free spaces 36 when the toothed ring nut 30 is in the rest configuration, and are so sized as to each accommodate a respective fin 16 when the filter-holder 7 is in the insertion configuration (FIG. 4).

In order to attract the filter-holder 7 and then keep it stable in the insertion configuration, each seat 37 is provided with one of the aforementioned permanent magnets 28 of the positioning device 26 so as to cooperate, when the filter-holder 7 is approached to the supporting body 6, with the permanent magnet 27 of the corresponding fin 16.

Preferably, the seats 37 and, consequently, the toothed ring nut 30, are arranged around the axis 20 so that, when the filter-holder 7 is in the insertion configuration, the handle 11 of the filter-holder 7 is arranged frontally to the operator and generally perpendicular with respect to the front wall 3 of the casing 2. Since in the first type of actuation of the coupling device 17, the fins 16 of the filter-holder do not rotate during the tight coupling of the coupling device 17, but only undergo an axial upward displacement, the filter-holder 7 remains in the same frontal configuration relative to the operator even when it is in the tight coupling configuration.

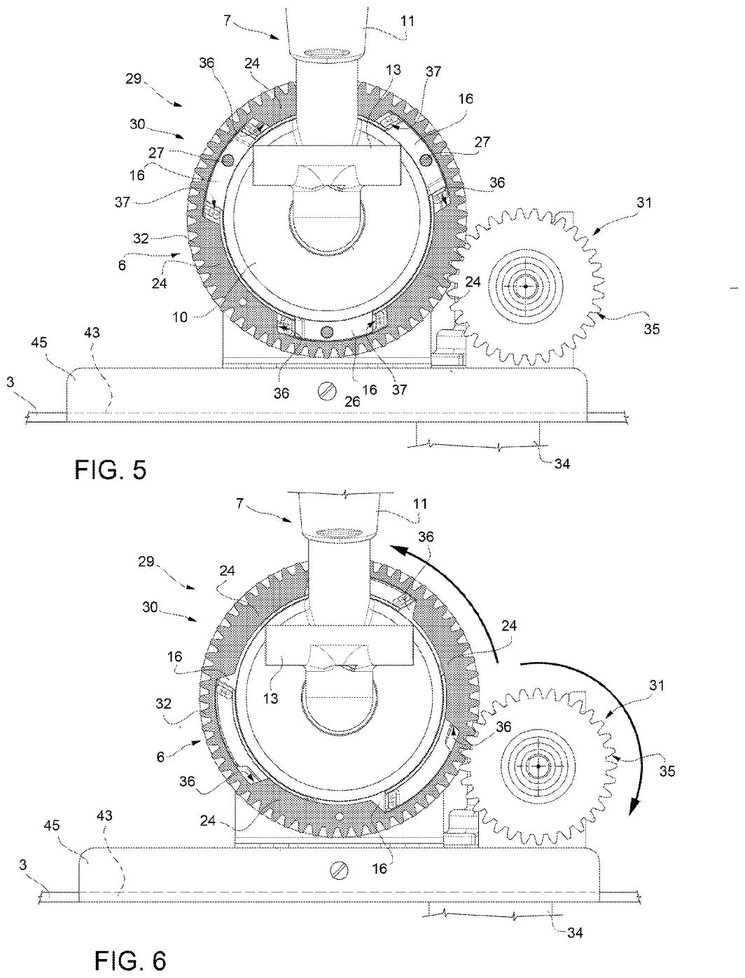

FIGS. 5 and 6 show how the coupling device 17 is tight-coupled by rotating the toothed ring nut 30 from the rest configuration, shown in FIG. 5, to the operating configuration, shown in FIG. 6.

In the rest configuration of the toothed ring nut 30, the filter-holder 7 is in the insertion configuration, in which the fins 16 engage the corresponding seats 37 and the edge 15 of the filter 14 engages the seal 23 frontally or is at least adjacent thereto.

As is clearly shown in FIG. 6, in order to move the toothed ring nut 30 from the rest configuration to the operating configuration, the drive device 31 is operated to impart to the toothed ring nut 30 a rotation of such an extent as to cause the transverse projections 24 and the fins 16 to overlap, at least partially. During this rotation, the abutment planes 25 of the transverse projections 24 slide along the inclined planes 18 of the fins 16, imparting an upward thrust to the latter, and thus to the entire filter-holder 7.

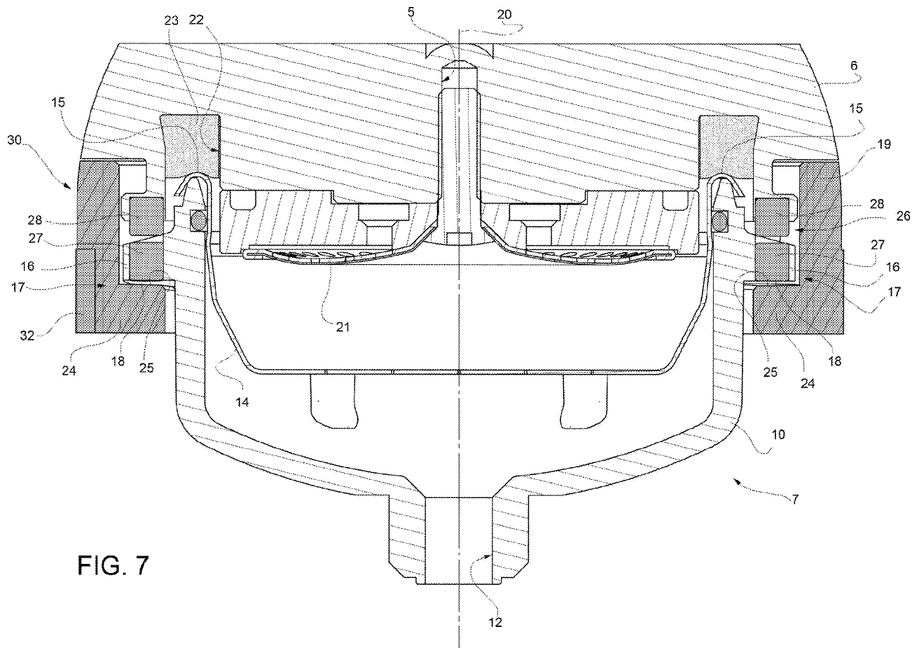

As shown in FIG. 7, at the end of the rotation of the toothed ring nut 30, the filter-holder 7 is in the tight coupling configuration, in which the edge 15 of the filter 14 is compressed against the seal 23 so that the filter-holder 7 is fluid-tightly coupled to the supporting body 6.

Second Type of Actuation of the Coupling Device

FIGS. 8 to 15 and FIGS. 16 to 23 show respective embodiments of the coffee machine 1 operating according to the second type of actuation of the coupling device 17, i.e., the type in which the fins 16 rotate relative to the transverse projections 24 and the toothed ring nut 30 is angularly coupled to the fins 16 to rotate them about the axis 20.

In this embodiment, the transverse projections 24 are not carried by the toothed ring nut 30, but are integral with the tubular lateral wall 19. In particular, the transverse projections 24 are arranged along an end free edge of the tubular lateral wall 19, extend towards the axis 20, and the respective abutment planes 25 face the bottom wall of the supporting body 6.

Also in this embodiment, the transverse projections 24 are evenly distributed around the axis 20 and circumferentially define therebetween free spaces 36 of sufficient angular width to allow the fins 16 to pass through the free spaces 36 in a direction parallel to the axis 20.

In the sections corresponding to the free spaces 36, around the seal 23, the bottom wall of the supporting body 6 carries the permanent magnets 28 which, like in the previous embodiment, are designed to cooperate, when the filter-holder 7 is approached to the supporting body 6, with the permanent magnets 27 carried by the corresponding fins 16 in order to attract and retain, or help to retain, the filter-holder 7 in the insertion configuration.

As mentioned above, in the second type of actuation of the coupling device 17, the toothed ring nut 30 is angularly coupleable to the fins 16 and, hence, to the filter-holder 7, such that the filter-holder 7 is rotated around the axis 20 when it is actuated by the drive device 31.

The angular coupling between toothed ring nut 30 and filter-holder 7 is achieved when filter-holder 7 assumes the insertion configuration. Two examples of how this angular coupling can be achieved are given by the embodiments shown in FIGS. 8 to 15 and FIGS. 16 to 23, respectively.

In the embodiment shown in FIGS. 8 to 15, the toothed ring nut 30 is provided with a fork 38 configured to be arranged astride the handle 11 of the filter-holder 7 when the latter is in the insertion configuration, thereby making the filter-holder 7 and the toothed ring nut 30 angularly integral.

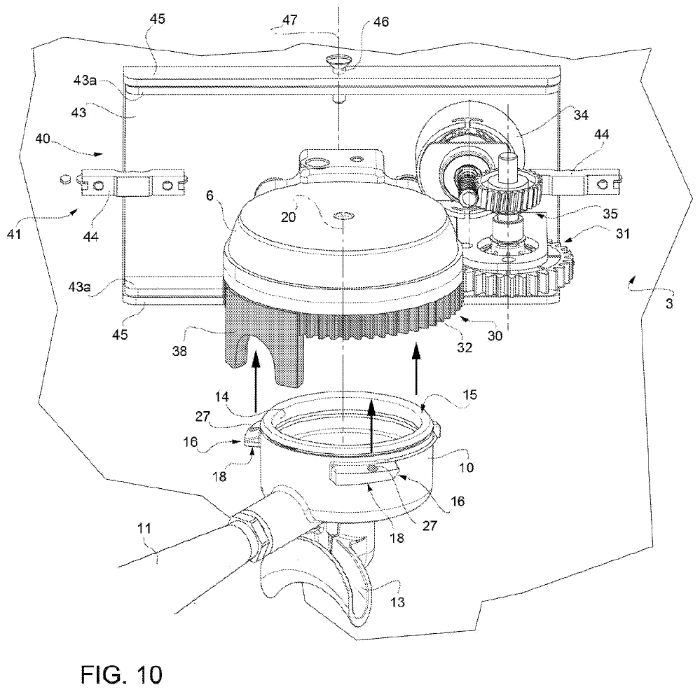

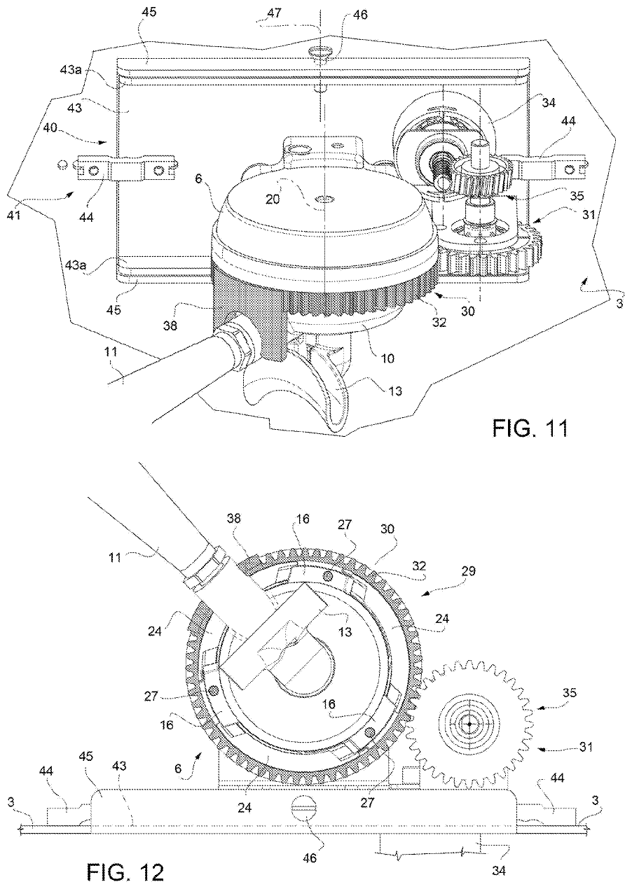

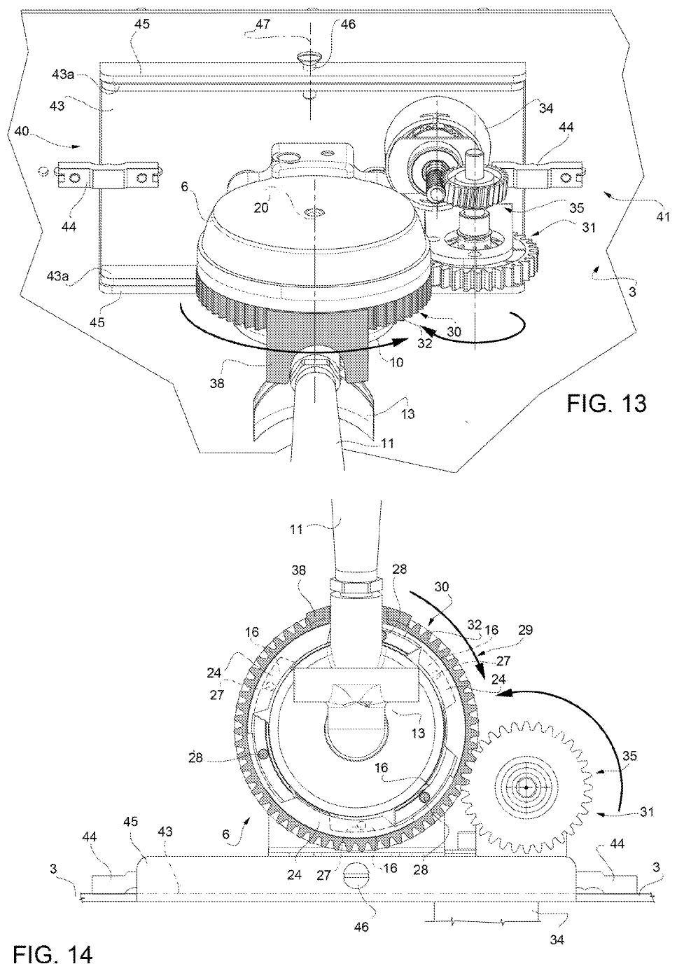

As shown in FIGS. 10, 11 and 13, conveniently, the toothed ring nut 30 is mounted on the supporting body 6 so that, when the toothed ring nut 30 is in the rest configuration, the fork 38 is angularly offset from a central configuration facing the operator and, preferably, is to the left of the operator (FIGS. 10 and 11). Preferably, moreover, the rest configuration of the toothed ring nut 30 is chosen so that, after the rotation of the toothed ring nut 30 from the rest configuration to the operating configuration, the fork 38 and, hence, the handle 11 of the filter-holder 7, is substantially in said central configuration in front of the operator (FIG. 13).

FIGS. 12 and 14 show how the coupling device 17 is tight coupled by rotating the toothed ring nut 30 from the rest configuration (FIG. 12) to the operating configuration (FIG. 14), and the corresponding rotation of the filter-holder 7 from the insertion configuration (FIG. 12) to the tight coupling configuration (FIG. 14).

In the insertion configuration of the filter-holder 7, the handle 11 is inserted into the fork 38, the fins 16 are arranged between the transverse projections 24 in corresponding free spaces 36, and the edge 15 of the filter 14 engages the seal 23 frontally or is at least adjacent thereto.

Operation of the drive device 31 causes the toothed ring nut 30 to rotate, dragging the filter-holder 7 with it and sliding the fins 16 on the transverse projections 24, thus moving the filter-holder 7 upwards.

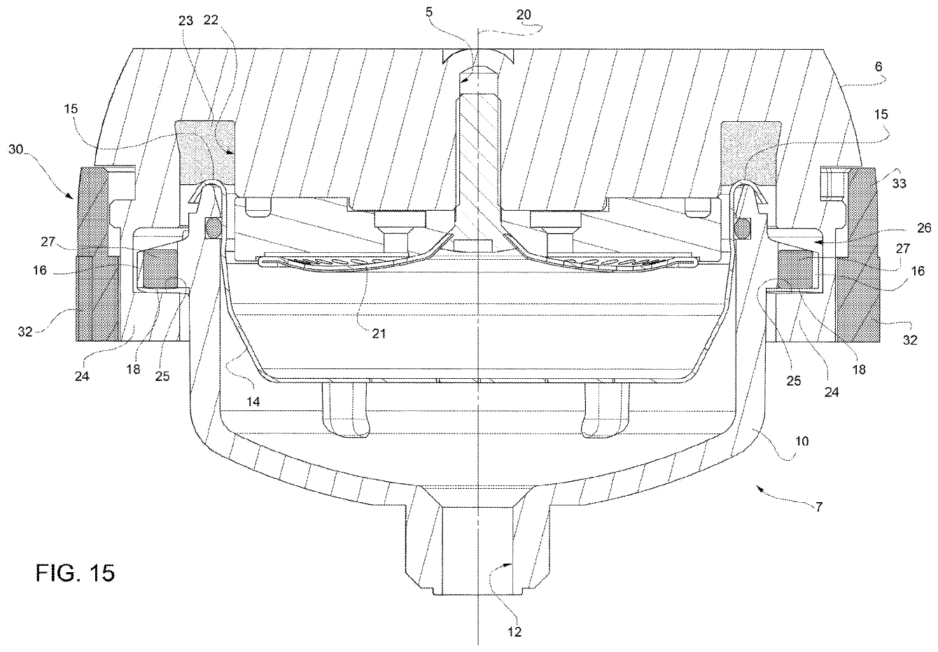

As shown in FIG. 15, at the end of the rotation of the toothed ring nut 30 and the filter-holder 7, the latter is in the tight coupling configuration, in which the edge 15 of the filter 14 is compressed against the seal 23, so that the filter-holder 7 is fluid-tightly coupled to the supporting body 6.

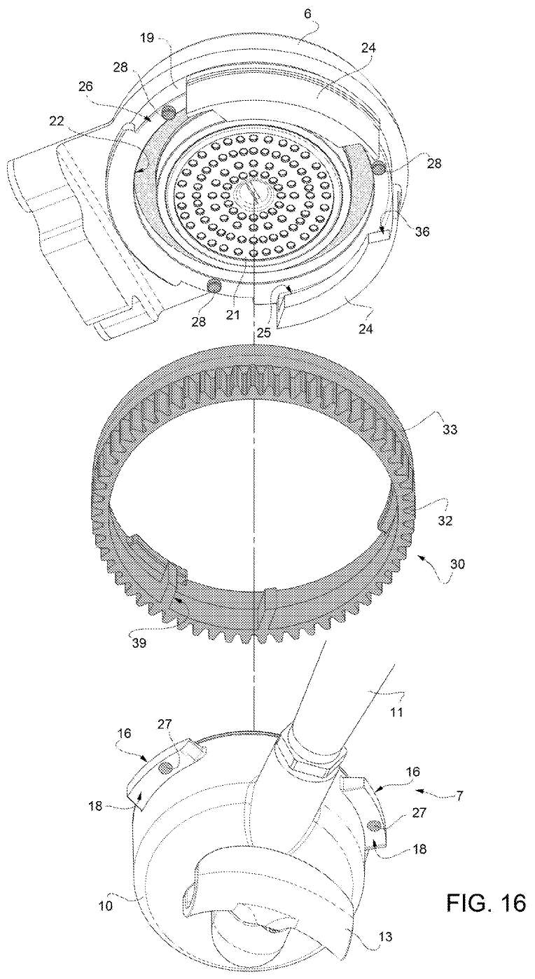

In the embodiment of FIGS. 16 to 23, the angular coupling between the toothed ring nut 30 and the filter-holder 7 is achieved by means of a seat or pocket 39 integral with the toothed ring nut 30 and configured to be engaged by one of the fins 16 of the filter-holder 7 when the toothed ring nut 30 is in the rest configuration and the filter-holder 7 is brought in the insertion configuration.

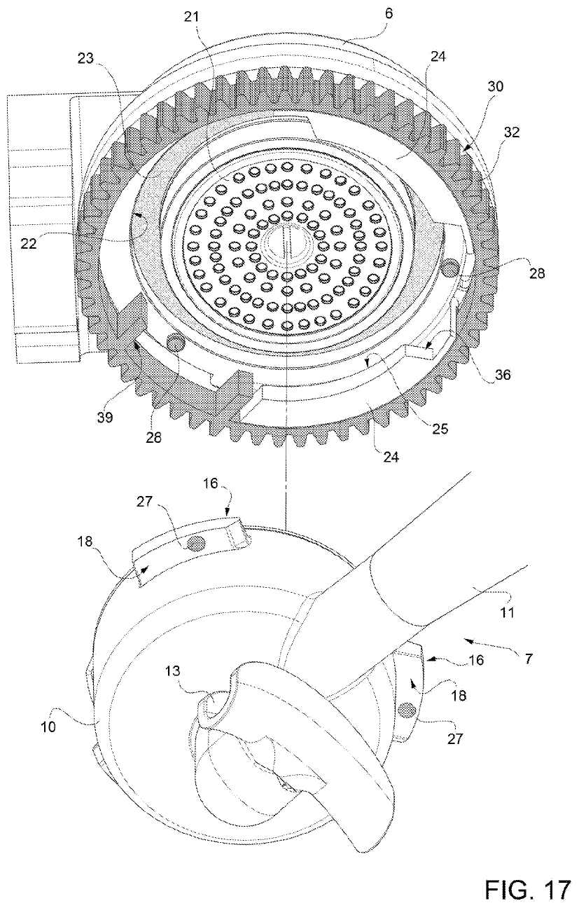

In particular, as shown in FIG. 17, the pocket 39 is defined by two walls projecting from an inner surface of the toothed ring 30, extends within one of the free spaces 36 between the transverse projections 24 and is so sized as to contain a fin 16 with relative precision.

When the toothed ring nut 30 is in the rest configuration and the filter-holder 7 is inserted in the supporting body 6, one of the fins 16 is inserted in the pocket 39 (FIG. 20) so as to constrain the filter-holder 7 to rotate together with the toothed ring nut 30 when the latter moves into the operating configuration. The rotation of the filter-holder 7 causes the fins 16 to engage the respective transverse projections 24, so resulting in the tight coupling of the coupling device 17 (FIG. 22). In this regard, it is noted that in the shown example, the size of the pocket 39 is such that, during rotation of the filter-holder 7, the pocket 39 would interfere with the transverse projection 24 intended to cooperate with the fin 16 inserted in the pocket 39. Therefore, said transverse projection 24 is absent and the tight coupling of the coupling device 17 is effectively achieved by engaging the other fins with the respective transverse projections 24. In a variant not shown, the pocket 39 is so sized and shaped as to allow it to be rotated despite the presence of the transverse projection 24 intended to cooperate with the fin 16 inserted in the pocket 39.

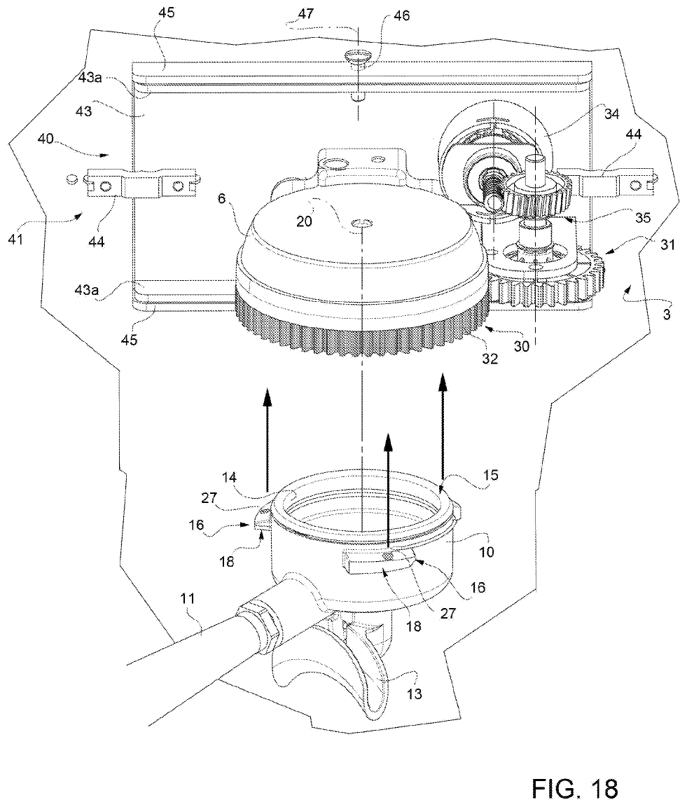

As shown in FIGS. 18, 19 and 21, the toothed ring nut 30 is conveniently mounted on the supporting body 6 so that, when the toothed ring nut 30 is in the rest configuration, it is possible to insert a fin 16 into the pocket 39 while keeping the handle 11 of the filter-holder 7 in a configuration angularly offset leftwards relative to a central configuration in front of the operator so that, after the rotation of the toothed ring nut 30 from the rest configuration to the operating configuration, the handle 11 is substantially in said central configuration in front of the operator.

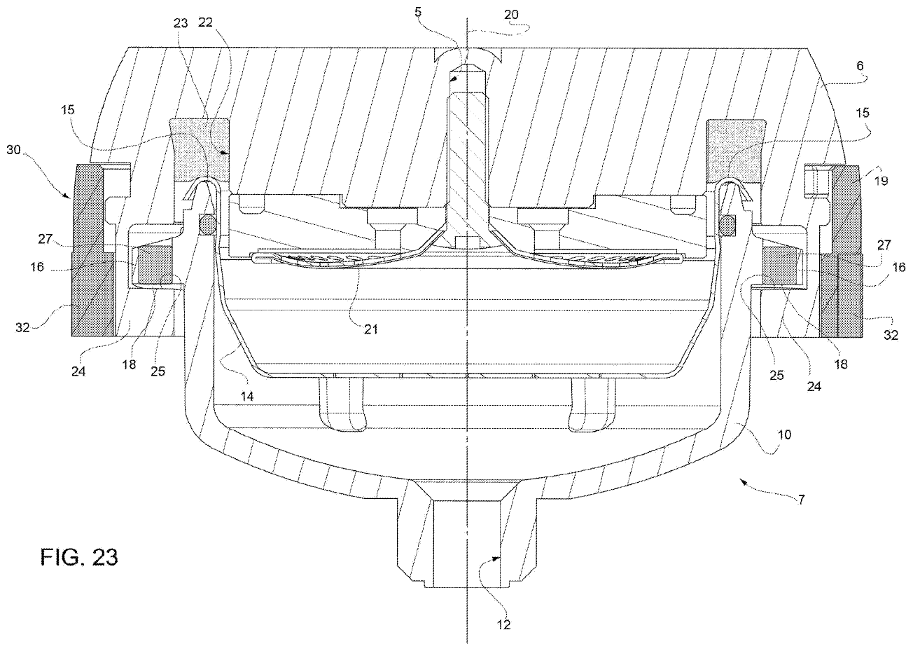

As shown in FIG. 23, at the end of the rotation of the toothed ring nut 30 and the filter-holder 7, the latter is in the tight coupling configuration, in which the edge 15 of the filter 14 is compressed against the seal 23, so that the filter-holder 7 is fluid-tightly coupled to the supporting body 6.

Regardless of whether the coupling device 17 belongs to the first type or second type of actuation described above, the automation device 29 of the coffee machine 1 is configured, as mentioned above, to automatically tight-couple and uncouple the coupling device 17 so as to replace, or assist, the operator in performing such actions.

In order to implement such an automatism, which from a practical point of view requires the activation of the drive device 31 which rotates the toothed ring nut 30, the automation device 29 comprises a user interface 40 operatively coupled to the drive device 31 and configured to allow an operator to cause the toothed ring nut 30 to rotate in both directions of rotation in order to tight-couple and uncouple the coupling device 17.

In a basic embodiment not shown in the accompanying FIGS., the user interface 40 may comprise a simple button or rocker switch with two or more positions, or one or more touch keys, or a touch-sensitive panel capable of detecting simple touches or more complex gestures made by an operator.

In a advanced embodiment shown in the accompanying FIGS., according to a different and independent aspect of the disclosure, the user interface 40 is configured to transform actions performed manually by an operator on the filter-holder 7 into corresponding electrical commands for the drive device 31, such that the toothed ring nut 30 is rotated in opposite directions of rotation and for a given time.

In particular, the user interface 40 comprises:

an electronic sensory system 41 configured to sense actions by an operator on the handle 11 of the filter-holder 7 and output an electrical output indicative of the actions by an operator on the handle 11 of the filter-holder 7, and

an electronic control unit 42 communicatively coupled with, in particular electrically connected to, the electronic sensory system 41 and the drive device 31 to receive the electrical output of the electronic sensory system 41 and to generate corresponding electrical commands for the drive device 31 based on the received electrical output, so as to cause the toothed ring nut 30 to rotate in opposite directions of rotation to tight-couple and uncouple the coupling device 17 in response to actions made by an operator on the filter-holder 7.

As shown in FIG. 1, the electronic sensory system 41 comprises a panel or plate 43, which is mounted on the front wall 3 and supports the supporting body 6, and one or more sensors 44 coupled to the plate 43 to sense forces applied to the plate 43 directly or indirectly through the filter-holder 7.

Conveniently, motion sensors 44 coupled to the plate 43 may be used as sensors 44 so as to sense (micro-)movements of the plate 43 caused by actions of an operator on the plate 43 either directly or indirectly, through the filter-holder 7.

The number, the technology and the arrangement of the motion sensors 44 are chosen such that they allow to sense (micro-)movements of the plate 43 caused by actions that are wished to be sensed of an operator on the plate 43 either directly or indirectly, through the filter-holder 7.

Conveniently, load cells 44 can be used as motion sensors 44, which are explicitly referred to in this description without losing generality.

Furthermore, since, by convention, the filter-holder of a coffee machine is rotated by an operator counterclockwise (rightwards with respect to the operator) to be locked on the supporting body and clockwise (leftwards with respect to the operator) to be unlocked, conveniently, the number, technology and the arrangement of the motion sensors are chosen such that they allow sensing (micro-)movements of the plate 43 caused by the force applied by the operator to the filter-holder 7 in order to rotate the latter anti-clockwise and clockwise.

In this embodiment, the electronic control unit 42 is programmed to:

determine, based on the electrical outputs of the load cells 44, the movements of the plate 43 caused by the actions manually performed by an operator on the handle 11 of the filter-holder 7, and

generate electrical commands for the drive device 31 such that the latter causes the toothed ring 30 to rotate from the rest configuration to the operating configuration when the load cells 44 sense a movement of the plate 43 caused by a rightward (counterclockwise) thrust applied to the filter-holder 7 by the operator, and, conversely, from the operating configuration to the rest configuration when the load cells 44 sense a movement of the plate 43 caused by a leftward (clockwise) thrust applied to the filter-holder 7 by the operator.

In the embodiment shown in the accompanying FIGS., the plate 43 has a rectangular shape and is delimited by a substantially horizontal lower and upper edges, and by two substantially vertical lateral edges. The lower and upper edges have respective extensions 43a projecting perpendicularly from the plate 43 outwards from the front wall 3 and arranged facing and contiguous with respective brackets 45 projecting from the lower and upper sides of a window in the front wall 3 in which the plate 43 is inserted.

Preferably, each extension 43a is connected to the respective bracket 45 by means of a pin 46 arranged substantially in the centre of the bracket 45 and coaxial to the other pin 46 so as to define, with the latter, a vertical rotation axis 47, about which the plate 43 may oscillate, in opposite directions, when the operator imparts a rightward or leftward thrust to the supporting group 6 through the filter-holder 7.

In order to sense the movement, i.e., the oscillation, of the plate 43, the load cells 44 are arranged between the plate 43 and the front wall 3 at the lateral edges of the plate 43, on the outside of the front wall 3.

In any case, the embodiment shown in FIGS. 1-23 is only an example of how many load cells 44 may be required and how they should be arranged with respect to the plate 43 and the front wall 3 in order to sense movements of the plate 43 in response to the rightward and leftward thrust imparted by an operator to the filter-holder 7 inserted in the supporting body 6. The number, the configuration and the orientation of the load cells 44 depends in fact on the type of load cell used.

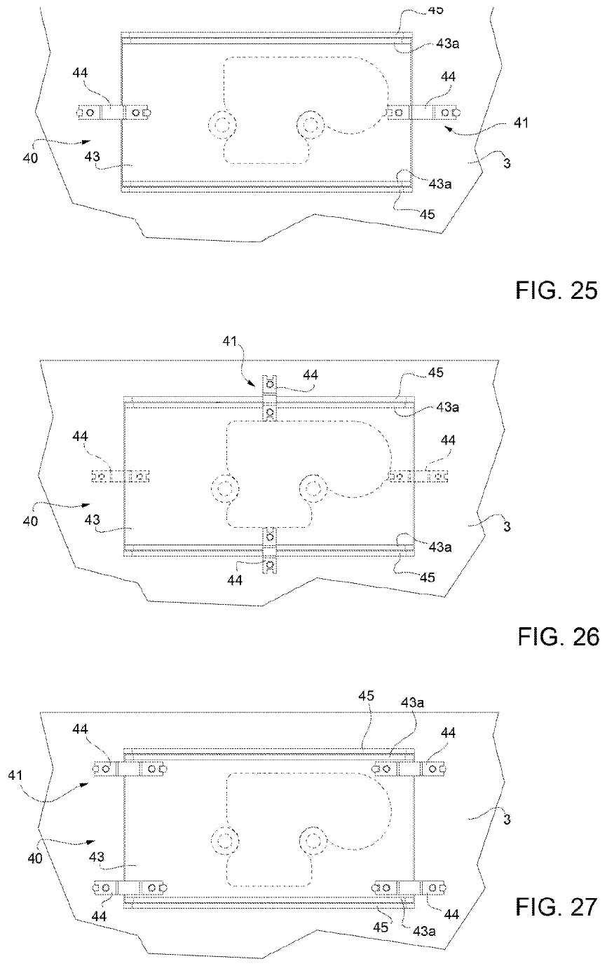

Furthermore, as shown in FIG. 25, the presence of the pin 46 is also optional since the number and the arrangement of the load cells 44 may be sufficient to give the plate 43 and the movements thereof sufficient stability.

Finally, also the shape of the plate 43 shown in the accompanying FIGS. is purely for illustrative purposes and may be replaced by a mounting element of any shape and size as long as it is suitable to rigidly support the supporting body 6 and to allow the load cells 44 to be applied for sensing (micro-)movements of the plate 43 in response to a rightward and leftward thrust imparted by an operator to the filter-holder 7 inserted in the supporting body 6.

Depending on whether the coupling device 17 operates according to the first type or the second type of actuation, the tight coupling thereof, which, as mentioned above, is caused by the rotation of the toothed ring nut 30, takes place either in a fully automatic mode, in which the rotation of the toothed ring nut 30 is exclusively controlled by the electronic control unit 42 through the drive device 31, or, respectively, in a partially automatic mode, in which the rotation of the toothed ring nut 30 is carried out partly manually by the operator and partly automatically by the drive device 31.

In fact, in the first type of actuation, in which the filter-holder 7 is not rotated between the insertion configuration and the tight coupling configuration and the transverse projections 24 are carried by the toothed ring nut 30 to move relative to the fins 16, the tight coupling of the coupling device 17 occurs in a completely automatic manner when an operator places the filter-holder 7 in the insertion configuration and imparts a rightward thrust (if the convention is followed, or leftwards) as if he wanted to rotate it to lock it, thus causing a movement (oscillation) of the plate 43, corresponding electrical outputs of the load cells 44 and operation of the drive device 31, consequently the rotation of the toothed ring nut 30 in the operating configuration, in response to an electrical command from the electronic control unit 42.

Conversely, a thrust in the opposite direction, in this case to the left, imparted by the operator to the filter-holder 7 as if he wanted to unlock it to remove it, causes an opposite movement of the plate 43 and consequently the rotation of the toothed ring nut 30 from the operating configuration to the rest configuration.

On the other hand, in the second type of actuation, in which the filter-holder 7 is integral with the toothed ring nut 30 when the filter-holder 7 is in the insertion configuration and is rotated to move between the insertion configuration and the tight coupling configuration so as to cause the fins 16 to engage to, or disengage from, the transverse projections 24, the tight coupling of the coupling device 17 takes place in a partially automatic manner, that is, it occurs in a manual “servo-assisted” manner.

In particular, when the operator places the filter-holder 7 in the insertion configuration and imparts a rightward thrust (if the convention is followed, or leftwards), the filter-holder 7 actually starts rotating towards the tight coupling configuration but, at the same time, the load cells 44 senses a consequent thrust on the plate 43 and, consequently, the electronic control unit 42 activates the drive device 31 which rotates the toothed ring nut 30 into the operating configuration, thus completing the tight coupling of the coupling device 17 without the operator having to exert any more force on the filter-holder 7.

The uncoupling of the coupling device 17 is mainly automatic as the thrust imparted by the operator to the filter-holder 7 in the opposite direction, in this case to the left, does not have to be of such an extent as to overcome the tight coupling force, but it is sufficient that it is suitable for being sensed by the load cells 44 through the movement of the plate 43 so as to cause the rotation of the toothed ring nut 30 from the operating configuration to the rest configuration and, hene, the return of the filter-holder 7 to the insertion configuration.

It goes without saying that the tight coupling and uncoupling of the coupling device 17 may be achieved by acting directly on the plate 43, in particular by imparting thrusts directly on the plate 43, on opposite sides of the supporting body 6.

Finally, in a preferred embodiment, the automation device 29 is configured to control not only the tight coupling and uncoupling of the coupling device 17, but also to start and stop beverage delivery in response to appropriate actions manually performed by the operator on the handle 11 of the filter-holder 7.

Preferably, the delivery of the beverage is controlled similarly to that described above for the tight coupling of the coupling device 17 and, in particular, is carried out by means of load cells 44 which are mounted between the plate 43 and the front wall 3 to sense a movement of the plate 43 in directions that are different from the movements caused by the thrusts imparted to the filter-holder 7 to and from the tight coupling configuration.

The load cells 44 provided for this purpose may be the same as those intended to sense the movements of the plate 43 when tight coupling and uncoupling the coupling device 17, or may be distinct from those intended to sense the movements of the plate 43 when tight coupling and uncoupling the coupling device 17 and arranged in appropriate positions with respect to the plate 34. For the sake of simplicity, in the accompanying FIGS. all load cells 44 are shown with the same reference number, regardless of the type of movement they are intended to sense.

In a preferred embodiment, the command to start and stop the beverage delivery is imparted by the operator by exerting on the handle 11 of the filter-holder 7, when the latter is arranged in the tight coupling configuration, an upward and, respectively, a downward thrust. Since the filter-holder 7 is integrally coupled to the supporting body 6, the thrust imparted to the filter-holder 7 is transmitted to the plate 43 and is sensed by the load cells 44, whose electrical outputs cause the electronic control unit 42 to control the start or stop of a pump (not shown) that supplies water to the boiler 4.

In a different embodiment, the command to start and stop the beverage delivery may be given by the operator by applying to the handle 11 of the filter-holder 7, when the latter is arranged in the tight coupling configuration, a torque tending to rotate the handle rightwards and, respectively, leftwards.

FIGS. 25, 26 and 27 show examples of possible arrangements of the load cells 44 in order to sense the movements of the plate 43 caused by a thrust on the filter-holder 7 rightwards/leftwards and/or upwards/downwards.

In particular, FIG. 25 shows a situation in which the thrusts on the filter-holder 7 rightwards/leftwards and/or upwards/downwards are sensed by the same pair of load cells 44 arranged at the smaller sides of the plate 43.

FIG. 26 shows both the situation in which the thrusts on the filter-holder 7 rightwards/leftwards and/or upwards/downwards are sensed by the same pair of load cells 44 (shown in a continuous line) arranged at the larger sides of the plate 43, and the situation in which the thrusts on the filter-holder 7 rightwards/leftwards are sensed by a first pair of load cells 44 (shown in a dashed line) arranged at the smaller sides of the plate 43, while the thrusts on the filter-holder 7 upwards/downwards are sensed by a second pair of load cells 44 (shown in a continuous line) arranged at the larger sides of the plate 43.

In the end, FIG. 27 shows the situation in which the thrusts on the filter-holder 7 rightwards/leftwards and/or upwards/downwards are sensed by four load cells 44 arranged near the four vertices of the plate 43.

Similarly to what has been said for the tight coupling and uncoupling of the coupling device 17, in a basic embodiment, also for the command to start and stop the beverage delivery the user interface 40 may comprise a simple button or a rocker switch with two or more positions, or a pair of touch keys, or even a touch-sensitive panel capable of sensing simple touches or a more complex gesture made by the operator.

It follows from the foregoing that the user interface 40 according to the advanced embodiment may be of a type capable of controlling both the tight coupling/uncoupling of the coupling device 17 and the start/stop of beverage delivery in response to actions made by an operator on the filter-holder 7, or of a type capable of controlling only one of the tight coupling/uncoupling of the coupling device 17 and the start/stop of beverage delivery.

1. A coffee machine comprising:
a supporting body that delivers hot water for producing a beverage;
a filter-holder that is fillable with a brewing material and is releasably coupleable to the supporting body to receive the hot water therefrom for brewing the brewing material to produce the beverage;
a coupling device comprising a first coupling part mounted on and integral with the supporting body and a second coupling part carried by the filter-holder,
wherein the coupling device is configured to cause the filter-holder to be tight-coupled in a tight-coupling configuration to the supporting body starting from an insertion configuration in which the filter-holder is loosely inserted to the supporting body by a relative rotation of the first coupling part and the second coupling part; and
an automation device configured to cause the first coupling part and the second coupling part to relatively rotate at least partially automatically;
a motorised member of the automation device operable to relatively rotate the first coupling part and the second coupling part about an axis of the supporting body and in opposite rotational directions,
wherein the motorised member comprises a ring nut rotatably mounted on the supporting body to rotate about the axis and coupleable to the filter-holder when the filter-holder is in the insertion configuration to become angularly integral with the filter-holder, and
wherein the ring nut is operable to rotate the second coupling part relative to the first coupling part to move the filter-holder between the insertion configuration to the tight-coupling configuration.

2. The coffee machine of claim 1, wherein the ring nut comprises a seat configured to be engageable, when the filter-holder is in the insertion configuration, by a part of the filter-holder to cause the filter-holder and the ring nut to become angularly integral.

3. The coffee machine of claim 2, wherein the seat is defined by a fork integral with the ring nut and the seat is configured to be arrangeable astride a handle of the filter-holder when the filter-holder is in the insertion configuration to cause the filter-holder and the ring nut to become angularly integral.

4. The coffee machine of claim 2, wherein the seat is defined by a pocket integral with the ring nut and the seat is configured to be engageable by the second coupling part of the filter-holder when the filter-holder is in the insertion configuration so as to cause the filter-holder and the ring nut to become angularly integral.

5. A coffee machine comprising:
a supporting body configured to deliver hot water for producing a beverage;
a filter-holder fillable with a brewing material and configured to be releasably coupleable to the supporting body to receive hot water therefrom for brewing the brewing material to produce the beverage;
a coupling device comprising a first coupling part mounted on the supporting body and a second coupling part carried by the filter-holder;
wherein the coupling device is configured to cause the filter-holder to assume a tight-coupling configuration in which the filter-holder is tight-coupled to the supporting body starting from an insertion configuration in which the filter-holder is inserted loosely in the supporting body as a result of a relative rotation of the first coupling part and the second coupling part; and
an automation device configured to cause the first coupling part and the second coupling part to relatively rotate at least partially automatically,
wherein the automation device comprises a motorised member operable to relatively rotate the first coupling part and the second coupling part about an axis of the supporting body in opposite rotations directions,
wherein the motorised member comprises a ring nut rotatably mounted on the supporting body to rotate about the axis and carry the first coupling part,
wherein the ring nut is operable to rotate the first coupling part relative to the second coupling part to cause the filter-holder to assume the tight-coupling configuration completely automatically starting from the insertion configuration and vice versa, and
where the ring nut is angularly oriented around the axis to allow the filter-holder to be manually arrangeable in the insertion configuration by an upward movement of the filter-holder exclusively along the axis towards the supporting body.

6. The coffee machine of claim 5, wherein the supporting body is shaped to cooperate with the second coupling part when the filter-holder is in the insertion configuration to substantially prevent the filter-holder from rotating about the axis during rotation of the ring nut, so-as to assume one and the same configuration relative to an operator both in the insertion configuration and in the tight coupling configuration.

7. The coffee machine of claim 5, wherein the ring nut is angularly oriented around the axis so that in both the insertion configuration and in the tight-coupling configuration the filter-holder assumes, relative to an operator, a frontal configuration in which a handle of the filter-holder is arranged frontally relative to the operator.

8. The coffee machine of claim 1, further comprising,
a magnetic positioning device configured to ease positioning of the filter-holder the insertion configuration when approached to the supporting body,
wherein the positioning device comprises one or more first magnetic elements associated with the supporting body and one or more second magnetic elements associated with the second coupling part, and
wherein the first magnetic elements are arranged to cooperate magnetically with the second magnetic elements when the filter-holder is in, or is about to assume, the insertion configuration.

9. The coffee machine of claim 8,
wherein the filter-holder comprises a cup-shaped body having a bottom wall and an open end delimited by an edge, and the supporting body comprises a brewing hot water outlet and a seal surrounding the brewing hot water outlet,
wherein the first coupling part comprises a number of first projections and the second coupling part comprises a number of second projections,
wherein the second projections are arranged on the filter-holder to fail to interfere with the first projections when the filter-holder is in the insertion configuration and to slidably cooperate with the first projections during relative rotation of the first coupling part and the second coupling part
wherein the first projections and the second projections are so shaped as to cause, during the relative rotation, the filter-holder and the supporting body to move one towards the other so that, in the tight-coupling configuration, the edge of the filter-holder is fluid-tightly pressed against the seal, and
wherein the first magnetic elements are arranged on the bottom wall of the cup-shaped body, between the first projections, and the second magnetic elements are carried by respective fins in positions such that, when the filter-holder is approached to the supporting body, the first magnetic elements face corresponding second magnetic elements

10. A coffee machine comprising:
a supporting body designed to deliver hot water for producing a beverage;
a filter-holder configured to be fillable with a brewing material and to be releasably coupleable to the supporting body to receive the hot water for brewing the brewing material and producing the beverage;
a coupling device comprising a first coupling part mounted on the supporting body and a second coupling part carried by the filter-holder;
wherein the coupling device is configured to cause the filter holder to assume a tight-coupling configuration in which the filter-holder is tight-coupled to the supporting body: starting from an insertion configuration in which the filter-holder is inserted loosely in the supporting body, as a result of a relative movement of the first coupling part and the second coupling part;
an automation device configured to cause the first coupling part and the second coupling part to relatively move at least partially automatically; and
a positioning device designed to ease positioning of the filter-holder the insertion configuration
wherein the positioning device is a magnetic positioning device comprising one or more first magnetic elements associated with the supporting body and one or more second magnetic elements associated with the second coupling part, and
wherein the first magnetic elements are so arranged as to cooperate magnetically with the second magnetic elements when the filter-holder is in, or is about to assume, the insertion configuration.

11. The coffee machine of claim 10,
wherein the filter-holder comprises a cup-shaped body having a bottom wall and an open end delimited by an edge, and the supporting body comprises a brewing hot water outlet and a seal surrounding the brewing hot water outlet,
wherein the first coupling part comprises a number of first projections, and the second coupling part comprises a number of second projections,
wherein the second projections are arranged on the filter-holder so as to fail to interfere with the first projections when the filter-holder is in the insertion configuration and to slidably cooperate with the first projections during the-relative rotation of the first coupling part and the second coupling part,
wherein the first projections and the second projections are shaped to cause, during the relative rotation, the filter-holder and the supporting body to move one towards the other so that in the tight-coupling configuration the edge of the filter-holder is fluid-tightly pressed against the seal, and
wherein the first magnetic elements are arranged on the bottom wall of the cup-shaped body between the first projections and the second magnetic elements are carried by respective fins in positions such that, when the filter-holder is approached to the supporting body, the first magnetic elements face corresponding second magnetic elements

12. The coffee machine of claim 10,
wherein the automation device comprises a motorised member operable to relatively rotate the first coupling part and the second coupling part about an axis of the supporting body and in opposite rotation directions, and
wherein the first coupling part is integral with the supporting body and the motorised member comprises a ring nut rotatably mounted on the supporting body to rotate about the axis and configured to be coupleable to the filter-holder when the filter-holder is in the insertion configuration to become angularly integral with the filter-holder, and
wherein the ring nut is operable to rotate the second coupling part relative to the first coupling part to move the filter-holder from the insertion configuration to the tight coupling configuration, and vice versa.

13. The coffee machine of claim 12, wherein the ring nut comprises a seat configured to be engageable, when the filter holder is in the insertion configuration, by a part of the filter-holder to cause the filter-holder and the ring nut to become angularly integral.

14. The coffee machine of claim 13, wherein the seat is defined by a fork integral with the ring nut and the seat is configured to be arrangeable astride a handle of the filter-holder when the filter-holder, is in the insertion configuration to cause the filter-holder and the ring nut to become angularly integral.

15. The coffee machine of claim 13, wherein the seat is defined by a pocket integral with the ring nut and configured to be engageable by the second coupling part of the filter-holder when the filter-holder is in the insertion configuration to cause the filter-holder and the ring nut to become angularly integral.

16. The coffee machine of claim 10,
wherein the automation device comprises a motorised member operable to relatively rotate the first coupling part and the second coupling part about an axis of the supporting body and in opposite rotation directions,
wherein the motorised member comprises a ring nut, which is rotatably mounted on the supporting body to rotate about the axis and carries the first coupling part,
wherein the ring nut is operable to rotate the first coupling part relative to the second coupling part so as to cause the filter-holder to assume the tight-coupling configuration completely automatically starting from the insertion configuration, and vice versa, and
wherein the ring nut is angularly oriented around the axis to allow the filter-holder to be manually arrangeable in the insertion configuration by an upward movement of the filter-holder exclusively along the axis towards the supporting body.

17. The coffee machine of claim 16, wherein the supporting body is shaped to cooperate with the second coupling part when the filter-holder is in the insertion configuration to substantially prevent the filter-holder from rotating about the axis during rotation of the ring nut to assume one and the same configuration relative to an operator in both the insertion configuration and in the tight coupling configuration.

18. The coffee machine of claim 16, wherein the ring nut is angularly oriented around the axis so that in both the insertion configuration and in the tight-coupling configuration the filter-holder assumes, relative to an operator, a frontal configuration, in which a handle of the filter-holder is arranged frontally relative to the operator.

19. The coffee machine of claim 1,
wherein the ring nut has a toothing, and
wherein the automation device comprises an electric actuator and a gear transmission to kinematically couple the electric actuator and the ring nut.

20. The coffee machine of claim 1,
wherein, in the tight-coupling configuration, the filter-holder and the supporting body are fluid-tightly coupled.

21. The coffee machine of claim 1, further comprising:
a frame on which the supporting body is mounted;
wherein the automation device further comprises a user interface configured to sense an action by a user on the filter-holder or a force applied to the frame by a user, either directly or indirectly through the filter-holder, and to cause the coupling device to tight-couple and uncouple in response to sensed action or forces.

22. The coffee machine of claim 21, wherein the user interface is configured to sense either action by a user on the filter-holder selected from the group consisting of: rightward, leftward, upward, and downward, or a force applied directly by a user on an area of the frame.

23. The coffee machine of claim 22, wherein the user interface is further configured to sense either an action by a user on the filter-holder that is either rightward and leftward or upward and downward, or a force applied directly by a user on areas of the frame on opposite sides of the supporting body.

24. The coffee machine of claim 21, wherein the user interface is further configured to cause beverage delivery to start and stop in response to a sensed action or force.

25. The coffee machine of claim 21, wherein the user interface is further configured to deliver hot water to the filter-holder to start and stop in response to a sensed action or force.

26. The coffee machine of claim 21, wherein the user interface is further configured to sense rightward, leftward, upward, and downward actions by a user on the filter-holder and to cause the coupling device to tight couple and uncouple in response to sensed rightward and leftward actions, and the beverage delivery to start and stop in response to sensed upward and downward actions, or vice versa.

27. The coffee machine of claim 21, wherein the user interface comprises:
an electronic sensory system configured to sense an action by a user on the filter-holder or a force applied to the frame by a user either directly or indirectly through the filter-holder, and responsively output an electrical output indicative of a sensed action or force; and
an electronic control unit communicatively coupled to the electronic sensory system to receive the electrical output and to output electrical commands for the automation device based on the electrical output of the electronic sensory system to cause the coupling device to tight-couple and uncouple.
